(19) United States
(12) Patent Application Publication
(10) Pub. No.: US 2026/0050116 A1
(43) Pub. Date: Feb. 19, 2026

(54) LIGHT GUIDE MEMBER AND BACK LIGHT UNIT INCLUDING THE SAME

(71) Applicant: MEMSLUX, Yuseong-gu (KR)

(72) Inventors: Jeongmu LEE, Yuseong-gu (KR); Ho Won Lee, Yuseong-gu (KR); Suhyeon Kim, Yuseong-gu (KR)

(73) Assignee: MEMSLUX, Yuseong-du (KR)

(21) Appl. No.: 19/297,287

(22) Filed: Aug. 12, 2025

(30) Foreign Application Priority Data
Aug. 13, 2024 (KR) 10-2024-0108603

(51) Int. Cl. F21V 8/00; G02F 1/1335; G02F 1/13357

(52) U.S. Cl. CPC G02B 6/0036; G02F 1/133524; G02F 1/133615

(57) ABSTRACT

A light guide member includes: an incident surface; a pattern arrangement surface on which a plurality of patterns configured to reflect light incident through the incident surface are formed; and a light emitting surface through which the light reflected from the plurality of patterns is emitted. Each of the patterns is a concave pattern and defined by a plurality of surfaces formed on the pattern arrangement surface, the plurality of surfaces include a first surface that is convex in a direction toward the incident surface and a second surface that faces the first surface and is convex/concave in the direction toward the incident surface, an angle between the pattern arrangement surface and a cross-section obtained by cutting the first surface in a direction perpendicular to the incident surface is an obtuse angle, and an angle between the pattern arrangement surface and a cross-section obtained by cutting the second surface.

### CROSS-REFERENCE TO RELATED APPLICATIONS

This U.S. Non-Provisional patent application claims the benefit under 35 USC § 119 of Korean Patent Application No. 10-2024-0108603, filed on Aug. 13, 2024, the entire contents of which are hereby incorporated by reference herein, for all purposes.

### BACKGROUND

The present disclosure relates to a light guide member and a backlight unit including the same, and more particularly, to a light guide member capable of reducing an image defect and a backlight unit including the same.

FIG. 1 is a perspective view illustrating a conventional flat backlight unit.

Referring to FIG. 1, the conventional flat backlight unit includes a reflector, a light guide plate LGP, a diffuser sheet, a prism sheet H, a prism sheet V, a liquid crystal display LCD, and a light source CCFL or LED.

The light guide plate serves to emit light incident into a side surface upward from a flat surface, and a three-dimensional structure or a two-dimensional pattern is formed on a surface of the light guide plate.

Since the three-dimensional or two-dimensional diffused reflection patterns of the light guide plate emit light to both front and rear surfaces of the light guide plate, the reflector reflects light to the rear surface.

The diffuser sheet removes a dot caused by the patterns on the light guide plate.

The prism sheet compensates a traveling direction of light emitted in a state of being inclined to a vertical direction, so that the light is emitted in the vertical direction. To this end, two prism sheets are required for each of the horizontal and vertical directions.

Since each of the diffuser sheet and the prism sheet of the conventional backlight unit in FIG. 1 has a multi-layer sheet structure (i.e., a composite sheet), a thickness of the backlight unit increases. Also, this causes a limitation of increase of manufacturing costs and degradation in optical efficiency. Furthermore, since the conventional backlight unit in FIG. 1 is opaque, the conventional backlight unit may not be used as a light guide plate that is transparent and emits light.

FIG. 2 is a view illustrating types of image defects that may occur in a single light guide plate.

When a pattern of the light guide plate is not properly designed, a predetermined image defect may occur on a light emitting surface of the light guide plate. The image defect includes a rainbow pattern and a searchlight phenomenon.

In FIG. 2, a view at the left side is a real photograph showing an image defect of a light guide plate when LED light is incident to an incident surface of the light guide plate having a pattern that is not properly designed.

Referring to the view at the left side of FIG. 2, it may be known that two kinds of image defects occur on one surface of the light guide plate. A represents an image defect of the rainbow pattern, and B represents an image defect of the searchlight phenomenon.

The rainbow pattern in A of FIG. 2 represents that, when various light components guided within the light guide plate are not sufficiently mixed before being emitted through the light emitting surface. As a result, due to differences between wavelengths of respective light components, rainbow colors are shown in the image.

The searchlight phenomenon of B occurs because a specific light component is incident at a narrow angle due to refractive index properties when light from a LED light source is incident to an incident surface of the light guide plate. The searchlight phenomenon occurs when a component of incident light that is incident at a relatively narrow angle is mostly emitted through a light emitting surface due to the plurality of patterns of the light guide plate, which results in a visibly uneven image with bright and dark areas.

The conventional light guide plate relieves or eliminates the rainbow pattern and the searchlight phenomenon by arranging a plurality of optical films (diffuser films and/or prism films) on the light emitting surface of the light guide plate. Specifically, in the related art, the diffuser film serves to reduce the image defect, and the prism film serves to adjust a light emitting angle.

### SUMMARY

The present disclosure provides a light guide member capable of reducing an image defect without using a diffuser film or a prism film and a backlight unit including the same.

The present disclosure also provides a light guide member that may be mass-produced at low costs and a backlight unit including the same.

An embodiment of the present disclosure provides a light guide member including: an incident surface; a pattern arrangement surface on which a plurality of patterns configured to reflect light incident through the incident surface are formed; and a light emitting surface through which the light reflected from the plurality of patterns is emitted, in which each of the patterns is a concave pattern and defined by a plurality of surfaces formed on the pattern arrangement surface, the plurality of surfaces include a first surface that is convex in a direction toward the incident surface and a second surface that faces the first surface and is convex or concave in the direction toward the incident surface, an angle between the pattern arrangement surface and a cross-section obtained by cutting the first surface in a direction perpendicular to the incident surface is an obtuse angle, and an angle between the pattern arrangement surface and a cross-section obtained by cutting the second surface in a direction perpendicular to the incident surface is an obtuse angle.

In an embodiment, the plurality of surfaces may include: a first side surface disposed at one side between the first surface and the second surface; and a second side surface disposed at the other side between the first surface and the second surface, and each of the first side surface and the second side surface has a triangular or trapezoidal shape.

In an embodiment, one side closest to the light emitting surface in the first surface and one side closest to the light emitting surface in the second surface may be brought into contact with each other to form an edge, and the edge may be a curve.

In an embodiment, an angle between both ends of the first surface based on a center of a circle along which the first surface extends may be an acute angle.

In an embodiment, the first surface may have a width equal to or greater than 15 μm and equal to or less than 30 μm.

In an embodiment, the first surface may have a curvature equal to or greater than 5 μm and equal to or less than 30 μm.

In an embodiment, the first surface may have a width equal to or greater than a height of the pattern.

In an embodiment, the first surface may have an inclination angle equal to or greater than 50° and equal to or less than 60°.

In an embodiment, the light guide member may further include at least one light guide layer disposed below the light emitting surface.

An embodiment of the present disclosure provides a backlight unit including: an incident surface; a pattern arrangement surface on which a plurality of patterns configured to reflect light incident through the incident surface are formed; and a light emitting surface through which the light reflected from the plurality of patterns is emitted, wherein each of the patterns is a concave pattern and defined by a plurality of surfaces formed on the pattern arrangement surface, wherein the plurality of surfaces comprise a first surface that is convex in a direction toward the incident surface and a second surface that faces the first surface and is convex or concave in the direction toward the incident surface, wherein an angle between the pattern arrangement surface and a cross-section obtained by cutting the first surface in a direction perpendicular to the incident surface is an obtuse angle, and wherein an angle between the pattern arrangement surface and a cross-section obtained by cutting the second surface in a direction perpendicular to the incident surface is an obtuse angle; a light source disposed at a side of the incident surface of the light guide member; and a display panel disposed on the light emitting surface of the light guide member.

In an embodiment, the display panel may include a plurality of pixels, and a distance between the plurality of patterns may be equal to or less than one-third of a size of one pixel.

The present disclosure relates to a light guide member and a backlight unit including the same, and more particularly, to a light guide member capable of reducing an image defect and a backlight unit including the same.

According to an embodiment of the present disclosure, a light guide member includes: an incident surface; a pattern arrangement surface on which a plurality of patterns configured to reflect light incident through the incident surface are formed; and a light emitting surface through which the light reflected from the plurality of patterns is emitted. Here, each of the patterns is a concave pattern and defined by a plurality of surfaces formed on the pattern arrangement surface, the plurality of surfaces include a first surface that is convex in a direction toward the incident surface and a second surface that faces the first surface and is convex or concave in the direction toward the incident surface, an angle between the pattern arrangement surface and a cross-section obtained by cutting the first surface in a direction perpendicular to the incident surface is an obtuse angle, and an angle between the pattern arrangement surface and a cross-section obtained by cutting the second surface in a direction perpendicular to the incident surface is an obtuse angle.

### BRIEF DESCRIPTION OF THE FIGURES

The accompanying drawings are included to provide a further understanding of the inventive concept and are incorporated in and constitute a part of this specification. The drawings illustrate exemplary embodiments of the inventive concept and, together with the description, explain principles of the inventive concept. In the drawings:

FIG. 1 is a perspective view illustrating a conventional flat backlight unit;

FIG. 2 is a view illustrating kinds of image defects that may occur in a single light guide plate;

FIG. 3 is a perspective view illustrating a light guide member 100 according to an embodiment of the present disclosure;

FIG. 4 is a cross-sectional view taken along line A-A′ of the light guide member 100 in FIG. 3;

FIG. 5 is a view illustrating various cross-sections of the pattern 130 in FIG. 3;

FIG. 6 is a plan view illustrating a pattern arrangement surface 120 of the light guide member 100 in FIG. 3;

FIG. 7 is a perspective view illustrating the light guide member 100 in FIG. 3 along with an enlarged view illustrating a portion thereof;

FIGS. 8 and 9 are views for explaining a distance between a plurality of patterns 130 of the light guide member 100 in FIGS. 3 to 7;

FIG. 10 is a view illustrating an image tearing phenomenon for each of FIGS. 8 and 9;

FIG. 11 is a view for explaining the size of each pattern 130 of the light guide member 100 shown in FIGS. 3 to 7;

FIGS. 12 to 14 are views for explaining effects of the light guide member 100 having the plurality of patterns 130 in FIGS. 3 to 7;

FIGS. 15 and 16 are views for explaining whether an image issue is relieved or eliminated depending on a shape and size of each pattern 130 in FIGS. 3 to 7;

FIG. 17 is a view for explaining terminologies used in graphs in FIGS. 18 to 20;

FIG. 18 is a view for explaining effects of horizontal light emission according to a curvature of a first surface 131 of each pattern 130 of the light guide member 100 in FIGS. 3 to 7;

FIG. 19 is a view illustrating a vertical light distribution of light emitted through a light emitting surface of the light guide member 100 in which a top surface is not present between a first surface 131 and a second surface 133 in FIGS. 3 to 7;

FIG. 20 is a view illustrating the vertical light distribution of light emitted through the light emitting surface of the light guide member, in which a predetermined top surface is present between the first surface 131 and the second surface 133 in FIGS. 3 to 7;

FIG. 21 is a view for explaining a principle by which a light emission component at a high angle is generated depending on whether the top surface of the pattern 130 in FIGS. 3 to 7 is present; and

FIG. 22 is a cross-sectional view illustrating a light guide plate 100′ according to another embodiment of the present disclosure.

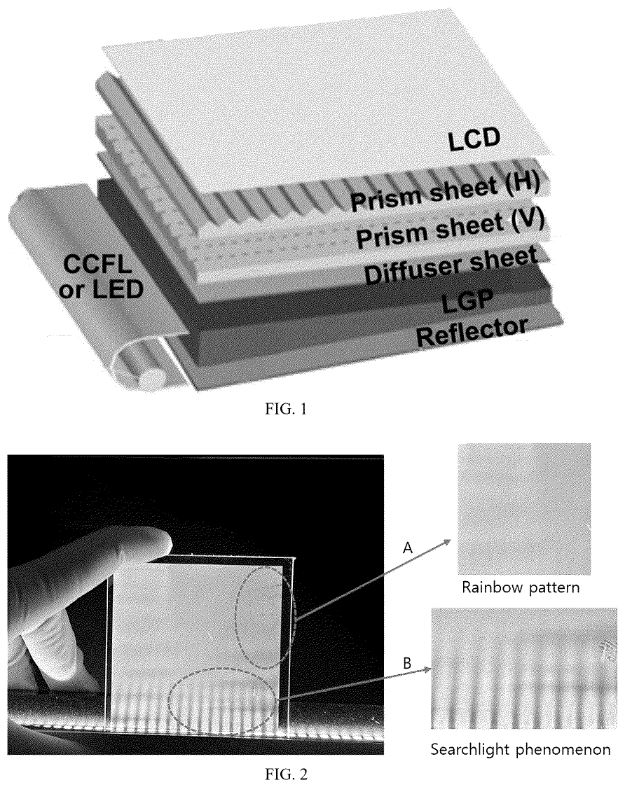

### DETAILED DESCRIPTION

Hereinafter, preferred embodiments of the present disclosure will be described in detail with reference to the accompanying drawings. It will be understood that the same reference numerals designate the same components throughout the drawings. For reference, detailed descriptions related to well-known functions or configurations will be ruled out in order not to unnecessarily obscure subject matters of the present disclosure.

The light guide member according to various embodiments of the present disclosure, as described in detail below, is capable of reducing or eliminating image defects such as rainbow patterns and searchlight phenomena—as mentioned in FIG. 2—without the use of separate films (e.g., diffuser films and/or prism films), relying solely on a plurality of patterns formed on the light guide member. In addition, manufacturing productivity can be enhanced, thereby reducing production costs.

Furthermore, the light guide member according to various embodiments of the present disclosure adopts a single plate structure with engraved patterns, incorporating: an optimized pattern design tailored to the intended application, optimized pattern coordinates considering the thickness and refractive index of the light guide member, and appropriate curvature design of the patterns according to the characteristics and arrangement of the light source.

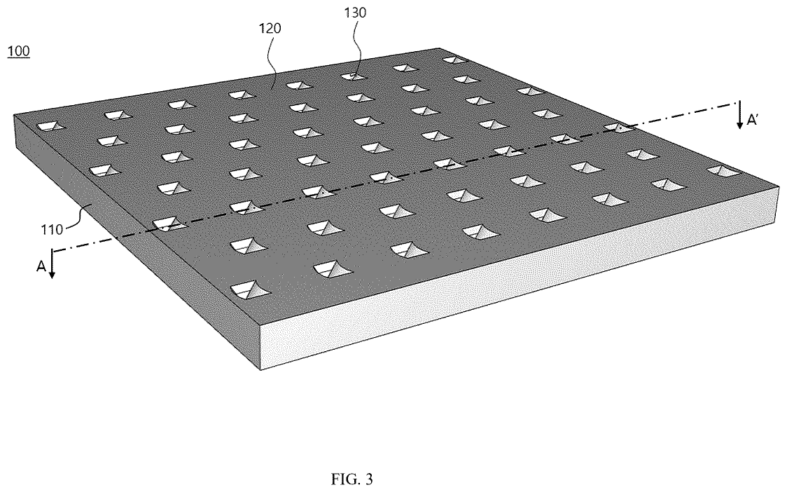

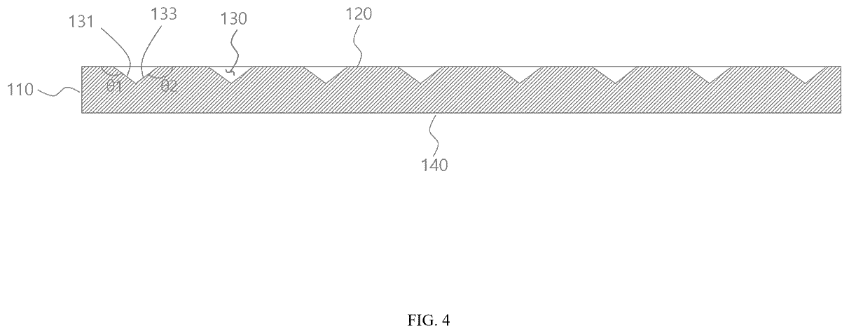

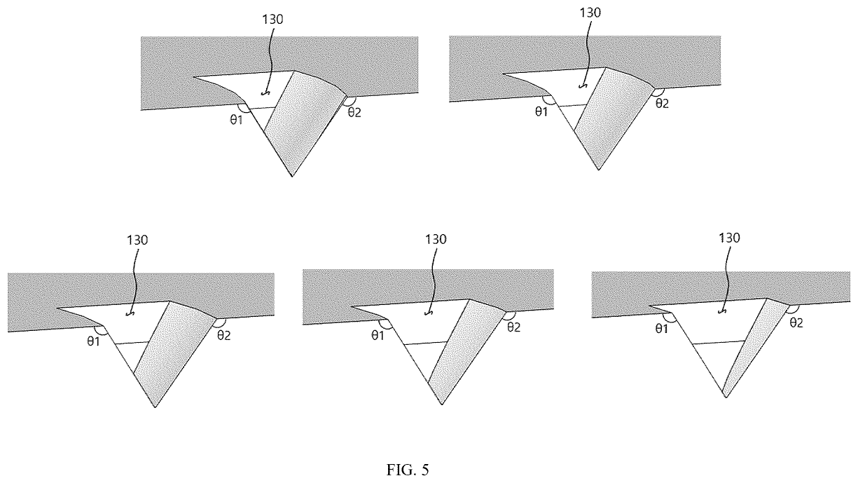

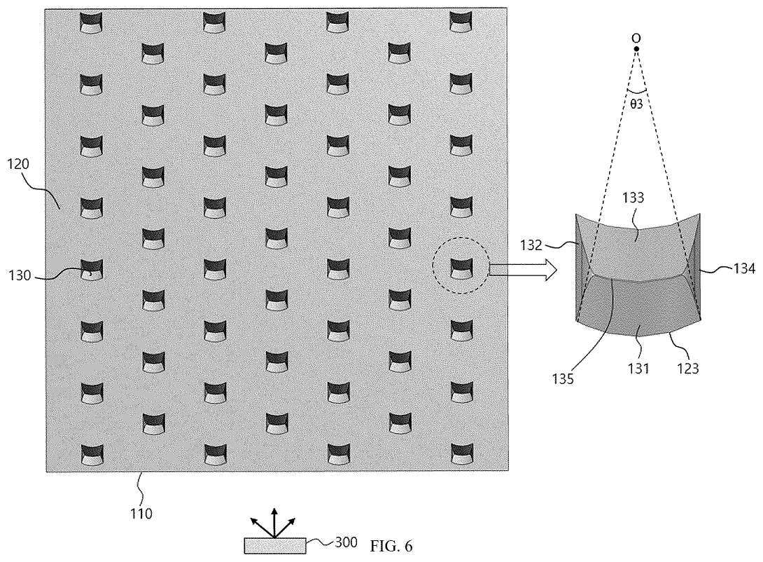

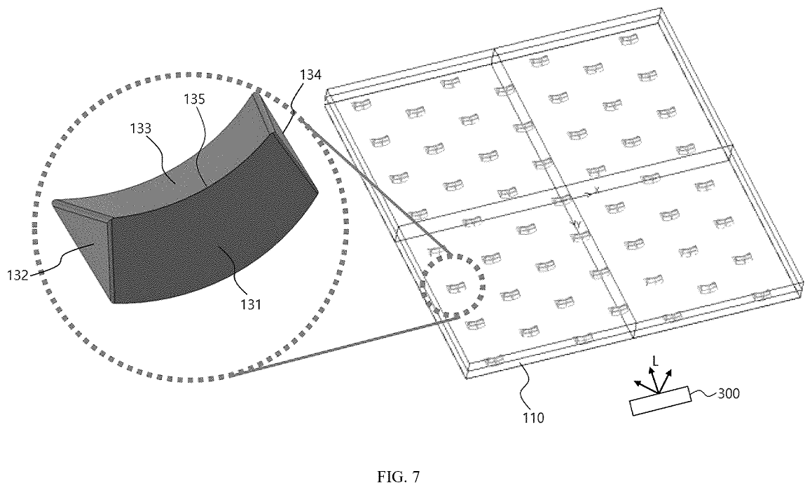

FIG. 3 is a perspective view of a light guide member 100 according to one embodiment of the present disclosure, FIG. 4 is a cross-sectional view taken along line A-A′ of the light guide member 100 shown in FIG. 3, FIG. 5 is a diagram showing various cross-sections of the pattern 130 depicted in FIG. 3, FIG. 6 is a plan view looking at the pattern arrangement surface 120 of the light guide member 100 shown in FIG. 3, and FIG. 7 is a perspective and partial enlarged view of the light guide member 100 shown in FIG. 3.

Referring to FIGS. 3 to 7, the light guide member 100 according to an embodiment of the present disclosure may include a single plate.

The light guide member 100 may have a plurality of side surfaces, and the plurality of side surfaces may include one side surface 110 to which light is incident, a pattern arrangement surface 120 on which a plurality of patterns 130 are formed, and a light emitting surface 140 from which light is emitted.

The plurality of patterns 130 formed on the pattern arrangement surface 120 may be concavely formed. The plurality of patterns 130 may be also referred to as a plurality of cavities or a plurality of concave patterns.

The plurality of patterns 130 may be spaced apart from each other on the pattern arrangement surface 120. The plurality of patterns 130 may be formed in a predetermined arrangement or in a random arrangement on the pattern arrangement surface 120.

Each pattern 130 may have a planar shape of a circle, a portion of a circle, a polygon, or an amorphous closed curve.

Each pattern 130 may be defined by a plurality of surfaces formed on the pattern arrangement surface 120.

The plurality of surfaces that form each pattern 130 include a first surface 131.

The first surface 131 faces the incident surface 110 to which light from the light source 300 is incident. The first surface 131 is a curved surface protruding toward the incident surface 110. The first surface 131 may be referred to as a front surface.

The plurality of surfaces that form each pattern 130 may further include a second surface 133.

The second surface 133 faces one side surface that faces the incident surface 110 among the plurality of side surfaces. The second surface 133 may be a curved surface that protrudes toward the incident surface 110 as with the first surface 131. The second surface 133 may be referred to as a rear surface. Although not illustrated in the drawings, the second surface 133 may be a curved surface recessed toward the incident surface 110.

One side of the first surface 131, which is closest to the light emitting surface 140, and one side of the second surface 133, which is closest to the light emitting surface 140, may be in contact with each other.

The above-described configuration may allow an edge 135 to be formed. That is, the first surface 131 and the second surface 133 may be in contact with each other at the edge 135. The edge 135 may be a curve having a predetermined curvature.

The plurality of surfaces that form each pattern 130 may further include a first side surface 132 and a second side surface 134. The first side surface 132 may be disposed at one end between the first surface 131 and the second surface 133, and the second side surface 134 may be disposed at the other end between the first surface 131 and the second surface 133. The first side surface 132 and the second side surface 134 face each other. Each of the first side surface 132 and the second side surface 134 may form an obtuse angle with the pattern arrangement surface 120. Here, as an inclination angle of each of the first side surface 132 and the second side surface 134 becomes closer to a right angle, effects of the cut-off effect decreases.

Each of the first side surface 132 and the second side surface 134 may have a triangular or trapezoidal shape.

Referring to FIGS. 4 and 5, a cross-sectional line obtained by cutting the first surface 131 in a direction perpendicular to the incident surface 110 is a straight line and forms a first angle θ1 with the pattern arrangement surface 120, and a cross-sectional line obtained by cutting the second surface 133 in a direction perpendicular to the incident surface 110 is also a straight line and forms a second angle θ2 with the pattern arrangement surface 120. Each of the first angle θ1 and the second angle θ2 is an obtuse angle, and the first angle θ1 and the second angle θ2 may be the same as or different from each other.

As illustrated in FIG. 5, although each of the first surface 131 and the second surface 133 is a curve in terms of various cross-sections of each pattern 130, a straight line may be obtained by cutting each of the first surface 131 and the second surface 133 in various directions perpendicular to the incident surface 110 illustrated in FIG. 4.

A tangent line at which the first surface 131 of the pattern 130 meets the pattern arrangement surface 120 may be a curve having a predetermined curvature (or a front curvature). As illustrated in FIG. 6, an angle θ3 between both ends of the first surface 131 based on a center O of a circle, to which a tangent line 123 at which the first surface 131 meets the pattern arrangement surface 120 follows, forms an acute angle. A distance from the center O of the circle to one end of the first surface 131 is a radius of curvature of the first surface 131.

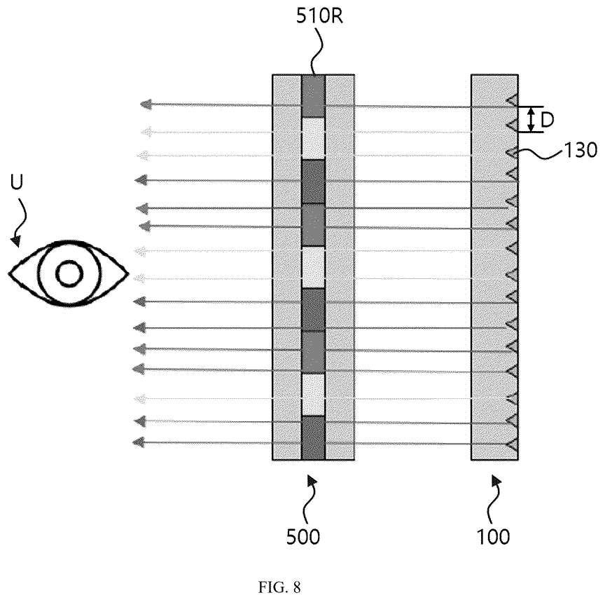

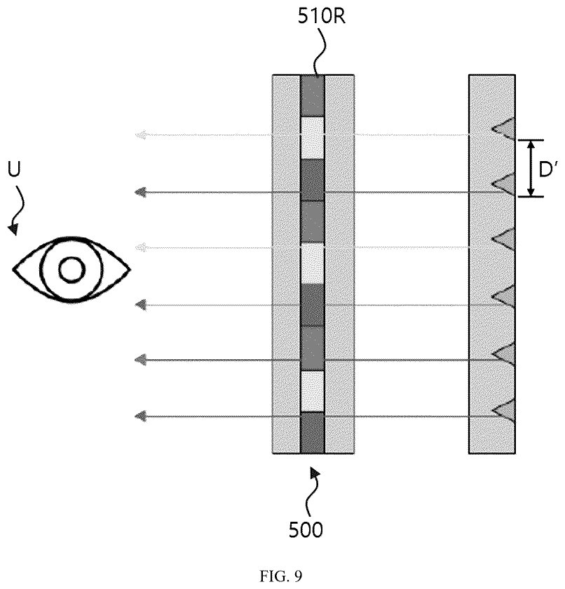

FIGS. 8 and 9 are views for explaining distances between a plurality of patterns 130 of the light guide member 100 in FIGS. 3 to 7, and FIG. 10 is a view illustrating an image tearing phenomenon for each of FIGS. 8 and 9.

A distance between the plurality of patterns 130 of the light guide member 100 in FIGS. 3 to 7 may be related to a size (width) of one pixel of a display panel 500 coupled with the light guide member 100.

Specifically, as illustrated in FIG. 8, a distance D between the plurality of patterns 130 may be less than one-third of a size (width) of one pixel 510R of the display panel 500. When the distance D between the plurality of patterns 130 is less than one-third of the width of the pixel 510R, an image degradation caused by image tearing may be prevented.

More specifically, when the distance D between the plurality of patterns 130 is less than one-third of the width of each pixel 510R of the display panel 500, all color information of each pixel 510R may be transmitted to a user U. It is preferred that the distance D between the plurality of patterns 130, which is less than one-third of the pixel size of the display panel 500, decreases.

In contrast, as illustrated in FIG. 9, when a distance D′ between the plurality of patterns 130 is greater than one-third of the width of the one pixel 510R of the display panel 500, the increased distance D′ between the plurality of patterns may result in the image tearing phenomenon like a sparkling phenomenon.

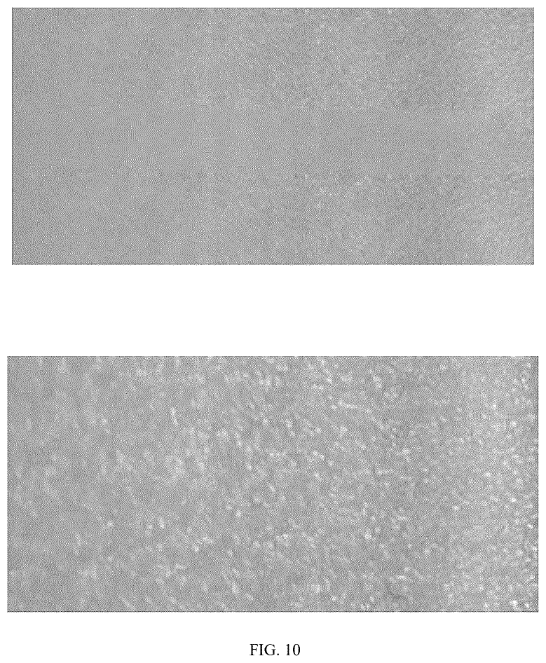

An upper drawing of FIG. 10 illustrates a case when the distance D between the plurality of patterns 130 in FIG. 8 is less than one-third of the width of each pixel 510R of the display panel 500, and a lower image of FIG. 10 illustrates a case when the distance D′ between the plurality of patterns 130 in FIG. 9 is greater than one-third of the width of each pixel 510R.

As described above, when the spacing D′ between the plurality of patterns 130 of the light guide member 100 is greater than one-third of the width of one pixel 510R of the display panel 500, the relatively large distance between the plurality of patterns 130 makes it difficult for each pixel 510R to accurately transmit all information to the user U. In contrast, when the distance D between the plurality of patterns 130 is less than one-third of the width of one pixel 510R, all the information may be easily transmitted to the user U, and thus, the image produced by the light guide member 100 is almost the same as that produced by the display panel 500.

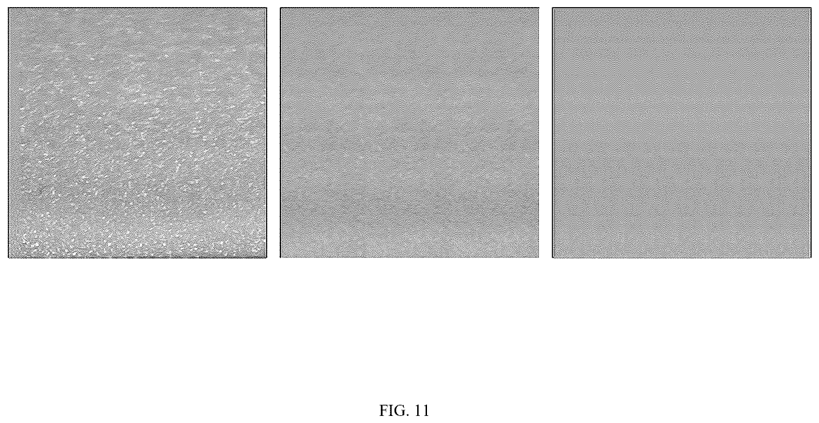

FIG. 11 is a view for explaining the size of each pattern 130 of the light guide member 100 in FIGS. 3 to 7.

Among three photographs in FIG. 11, a left photograph represents an image output from the display panel when a width (maximum width viewed from the incident surface 110) of the first surface 131 of each pattern 130 in FIG. 7 is 80 μm, a middle photograph represents an image output from the display panel when the width of the first surface 131 of each pattern 130 in FIG. 7 is 40 μm, and a right photograph represents an image output from the display panel when the width of the first surface 131 of each pattern 130 in FIG. 7 is 15 μm.

Referring to the three photographs in FIG. 11, it may be known that, as the size of each pattern 130 decreases, the sparkling phenomenon is reduced, and an image close to a surface is shown.

The first surface 131 of each pattern 130 of the light guide member 100 may have a width of 15 μm to 30 μm. The above-described width is obtained by considering that the pixel size of the current display panel has a size of 60 μm to 120 μm. Also, a pattern having a width less than 15 μm may have an unintended curvature during a manufacturing process, and a pattern having a width greater than 30 μm may cause the sparkling phenomenon when coupled with a liquid crystal (LC) of the display panel. Thus, a desirable width of the patterns is equal to greater than 15 μm and equal to less than 30 μm.

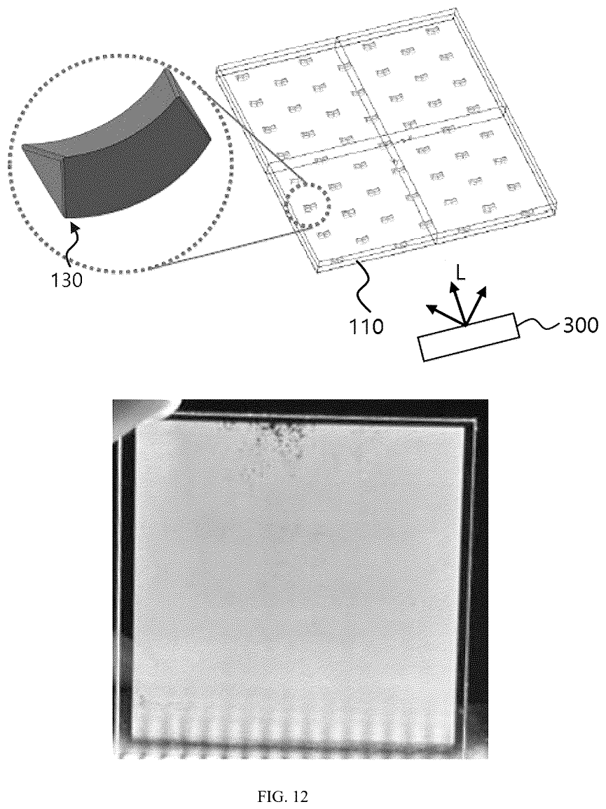

FIGS. 12 to 14 are views for explaining effects of the light guide member 100 having a plurality of patterns 130 in FIGS. 3 to 7.

FIG. 12 illustrates an image that is recognized by naked eye from the light emitting surface of the light guide member 100 having the plurality of patterns 130 in FIGS. 3 to 7 when light L from a light source 300 is incident to the incident surface 110 of the light guide member 100.

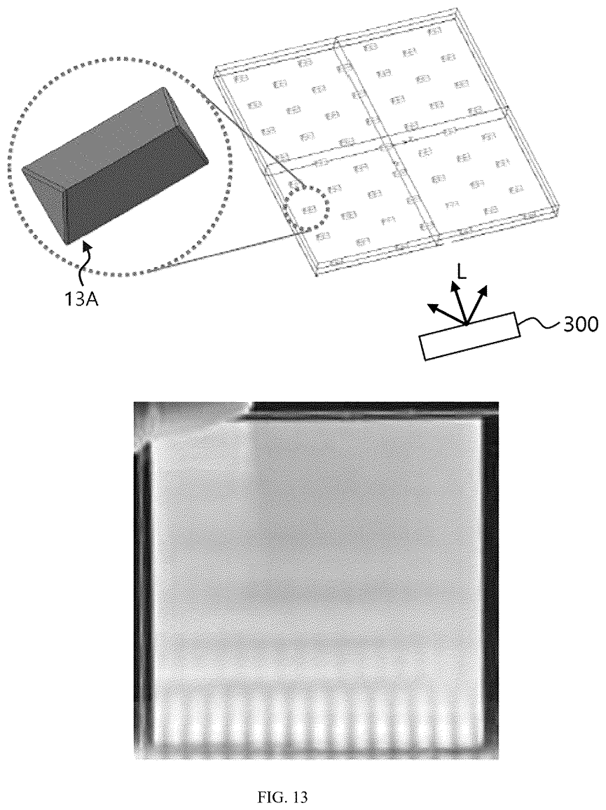

FIG. 13 illustrates an image that is recognized by naked eye from the light emitting surface of the light guide member having a plurality of flat patterns 13A when the light L from the light source 300 is incident to the incident surface of the light guide member.

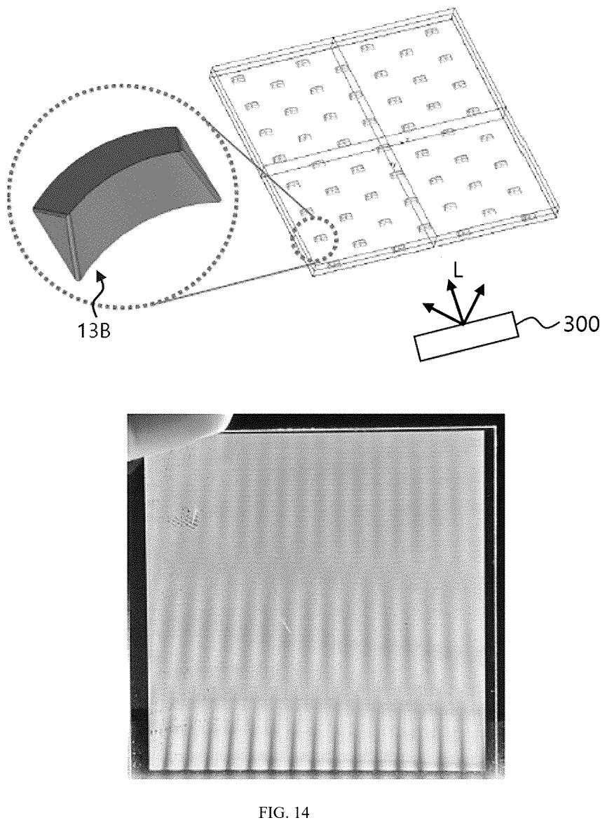

FIG. 14 illustrates an image that is recognized by naked eye from the light emitting surface of the light guide member having a plurality of concave patterns 13B when the light L from the light source 300 is incident to the incident surface of the light guide member. Here, a first surface of the concave pattern 13B is a curved surface recessed in a direction toward the incident surface.

In FIGS. 12 to 14, all conditions except for the plurality of patterns 130, 13A, and 13B are the same as each other. A state in which vertically extending areas form alternately bright and dark striped pattern in a specific areas is referred to as the searchlight phenomenon, and a state in which rainbow-shaped stripes are generated in a horizontal direction is referred to as the rainbow phenomenon.

Referring to FIGS. 12 to 14, when the images of the incident surfaces to which the light L is incident in respective light guide members are compared, it may be observed that the light guide member having the plurality of patterns 13B in FIG. 14 exhibits significantly more severe searchlight phenomenon relative to that of each of FIGS. 12 and 13 depending on arrangement of the light source 300. It may be also observed that the rainbow phenomenon is significantly more severe than that of FIGS. 12 and 13.

It may be observed in FIG. 12 that, although the same light source 300 as that in FIGS. 13 and 14 is used in FIG. 12, both the searchlight phenomenon and the rainbow phenomenon are relatively minimal, and an image recognized by naked eyes is close to that produced by a surface light source.

Also, an image issue may be eliminated by adjusting a curvature value that represents a degree of convexity of a front surface of the pattern 130 in FIG. 12. Hereinafter, descriptions will be provided with reference to the accompanying drawings.

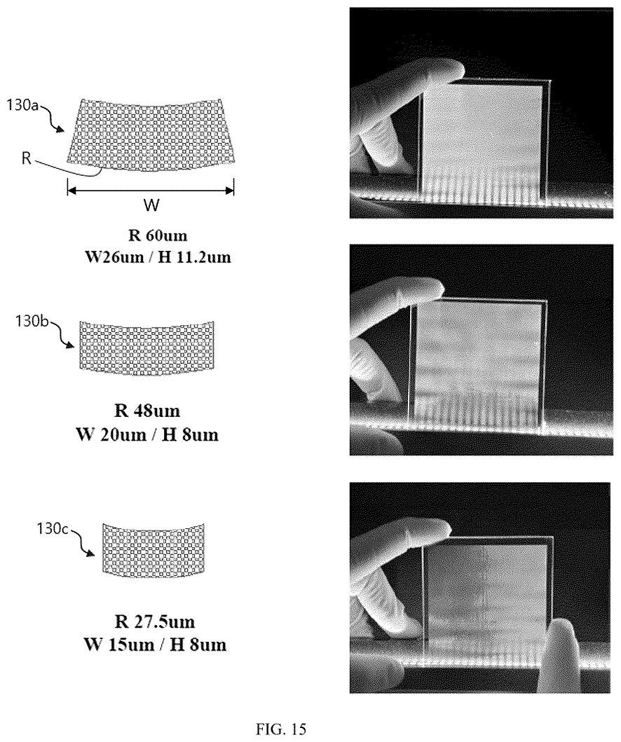

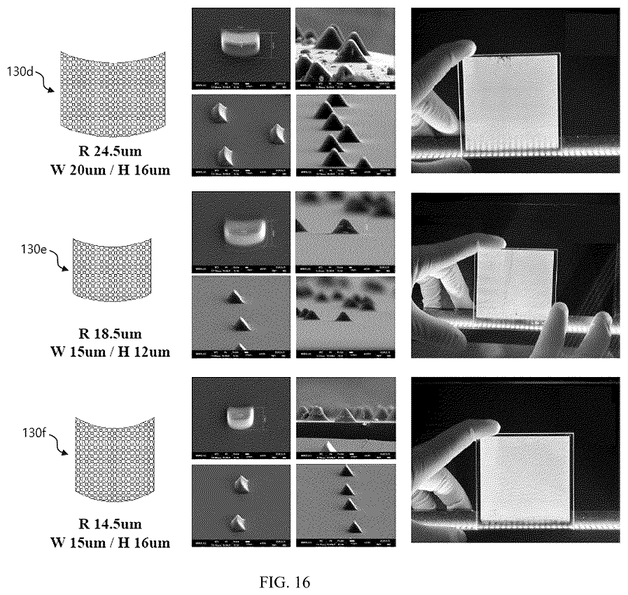

FIGS. 15 and 16 are views for explaining whether the image issue is relieved or eliminated depending on a shape and size of each pattern 130 in FIGS. 3 to 7.

Patterns 130a, 130b, and 130c at the left side in FIG. 15 are plan views of mask patterns of corresponding patterns, and each of the patterns has a predetermined curvature R, a predetermined width W, and a predetermined height H. The curvature R corresponds to the curvature of the first surface 131 (or front surface) of the pattern 130 in FIG. 7, the width W corresponds to a maximum width of the first surface 131 (or front surface) of the pattern 130 in FIG. 7, and the height H represents a minimum distance from an opening (not shown) of the pattern 130 to the edge 135 in FIG. 7.

Referring to the pattern shape 130a, 130b, and 130c at the left side and photographs at the right side in FIG. 15, it is observed that, as the curvature R of each of the pattern shapes 130a, 130b, and 130c decreases (i.e., as the convexity of each of the pattern shapes increases), the searchlight phenomenon is significantly relieved, and the rainbow phenomenon is also reduced.

Pattern shapes 130d, 130e, and 130f at the left side in FIG. 16 are plan views of mask patterns of corresponding patterns, and each of the pattern shapes has a predetermined curvature R, a predetermined width W, and a predetermined height H.

Referring to the pattern shapes 130d, 130e, and 130f on the left side and photographs at the right side in FIG. 16, when the curvature R of the pattern shape 130d is designed to be about 24.5 μm, the searchlight and the rainbow pattern are observed, and, when the curvature R of the pattern shape 130e is about 18.5 μm, the searchlight phenomenon is not observed with naked eyes, and the rainbow pattern is slightly observed. When the curvature R of the pattern shape 130f is further reduced to 14.5 μm, it may be known that the image issue such as the searchlight and the rainbow pattern is not recognized with naked eyes, and the entire light emitting surface of the light guide member is recognized as the light source.

As described above, surface lighting may be implemented by using only the light guide member without using the diffuser film or the prism film that is used to eliminate the conventional image issue when the curvature and size of each pattern 130 in FIGS. 3 to 7 are appropriately adjusted.

The first surface 131 of each pattern 130 may have the curvature R equal to or greater than 5 μm and equal to or less than 30 μm when each pattern 130 in FIGS. 3 to 7 has the width W equal to or greater than 15 μm and equal to or less than 30 μm. In particular, when the curvature R of the first surface 131 of each pattern 130 is equal to or greater than 5 μm and equal to or less than 30 μm, and the width W of the pattern 130 is equal to or greater than 15 μm and equal to or less than 30 μm, it may be observed that no image degradation occurs. Furthermore, when the curvature R of the first surface 131 of each pattern 130 is equal to or greater than 5 μm and equal to or less than 14.5 μm, and the width W of the pattern 130 is equal to or greater than 15 μm and equal to or less than 30 μm, the image issue such as the searchlight phenomenon and the rainbow patter is eliminated.

In terms of the width W and height H of each pattern 130, when the width W is greater than or equal to the height H of the pattern, optical characteristics such as transmittance, density, haze, and luminance are more efficient.

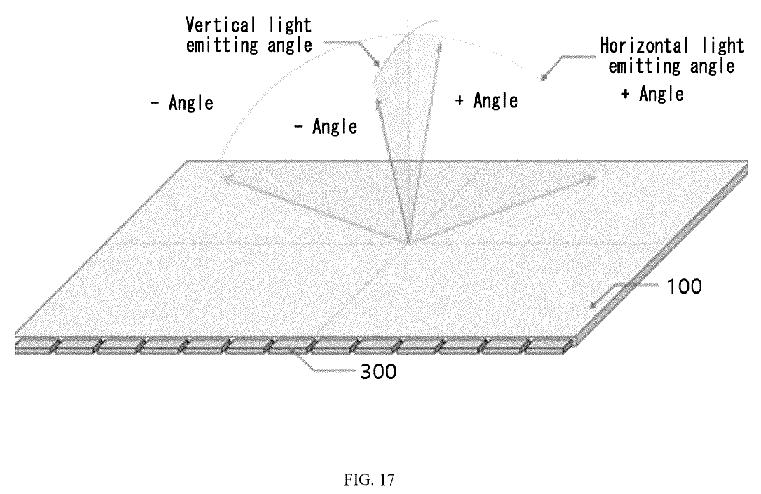

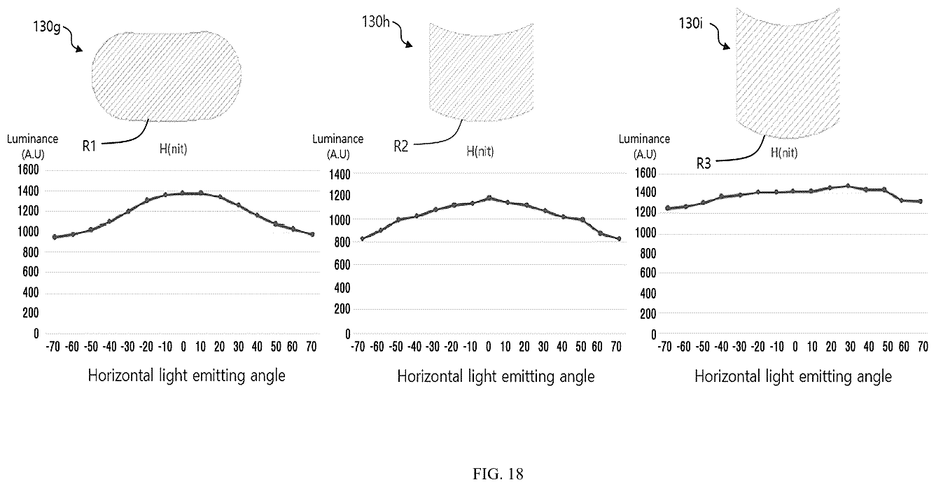

FIG. 17 is a view for explaining terminologies used in graphs of FIGS. 18 to 20, and FIG. 18 is a view for explaining effects of horizontal light emission based on the curvature of the first surface 131 of each pattern 130 of the light guide member 100 in FIGS. 3 to 7.

As illustrated in FIG. 18, a light emission distribution based on curvatures R1, R2, and R3 of front surfaces of respective pattern shapes 130g, 130h, and 130i reveals that a horizontal light emission distribution is varied based on the curvature of the first surface of each of the pattern shapes 130g, 130h, and 130i.

It may be observed that, as the curvature R1, R2, and R3 of the front surface of the pattern 130 increases (i.e., flatness of the pattern increases), a peak is formed close to a center of the horizontal light emission distribution. In contrast, it may be observed that, as the curvature of the front surface decreases, light is dispersed uniformly to all angles. Furthermore, the bright line phenomenon may be reduced or relieved by increasing the curvature of the front surface of the pattern (i.e., increasing the convexity of the pattern).

As described above, since the curvature of the front surface of the pattern 130 affects the output image, it may be known that a designer needs to design the curvature of the front surface of the pattern appropriately to design objective.

Referring to FIG. 18, when the curvature is designed as small as possible within designer's intended light emission distribution characteristics in an initial pattern design process may contribute to obtaining uniform light emission across entire area, and a flatter design may increase central luminance.

Referring again to FIGS. 3 to 7, the inclination angle (180°−θ₁) of the first surface 131 of each pattern 130 in the light guide member 100 may determine a path of a total reflection light emitting component of the pattern 130.

The inclination angle (180°−θ₁) of the first surface 131 affects a vertical peak. The inclination angle (180°−θ₁) of the first surface 131 may be in a range from 50° to 60°, and preferably about 52°. The preferred inclination angle (180°−θ₁) may be varied depending on a refractive index of the light guide member 100. When the inclination angle (180°−θ₁) is 52°, a peak may occur at 0° in a vertical light emission distribution, which may be varied based on the refractive index of the light guide member 100.

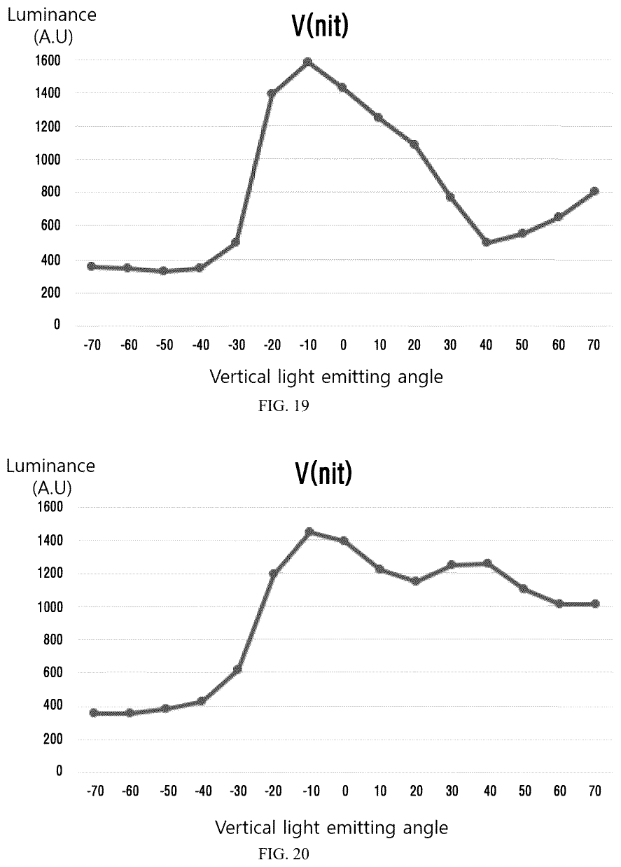

The first surface 131 and the second surface 133 of each pattern 130 of the light guide member 100 are in contact with each other through the edge 135, and there is no intervening surface (hereinafter, referred to as a top surface) between the first surface 131 and the second surface 133. A difference in vertical light emission distribution between a case when the top surface is present and a case when the top surface is not present will be described with reference to FIGS. 19 and 20.

FIG. 19 is a graph showing a vertical light emission distribution of light output from the light emitting surface of the light guide member 100 in which the top surface is not present between the first surface 131 and the second surface 133 in FIGS. 3 to 7, and FIG. 20 is a graph showing a vertical light emission distribution of light output from the light emitting surface of the light guide member 100 in which the top surface is present between the first surface 131 and the second surface 133 in FIGS. 3 to 7.

Referring to FIG. 19, since the top surface is not present between the first surface 131 and the second surface 133, only one peak exists around 0° due to the inclination angle of the first surface 131. Thus, it may be observed that a light emission intensity at the one peak is relatively high, and the light emission intensity at high angles (30° to) 70° is relatively low.

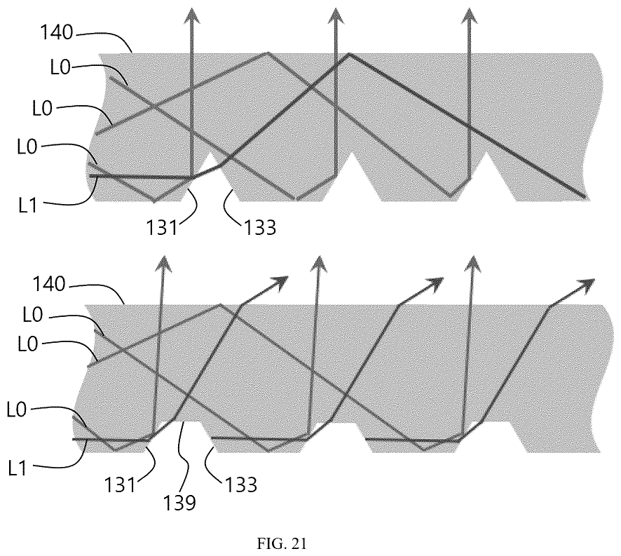

In contrast, referring to FIG. 20, since the top surface is present between the first surface 131 and the second surface 133, two peaks exist. One peak exists around 0° and another peak exists at a high angle between 30° and 70° due to the inclination angle of the first surface 131. It may be observed that the light emission intensity is distributed from 0° to the high angle. A principle by which light emission at the high angle occurs will be described with reference to FIG. 21.

FIG. 21 is a view for explaining a principle by which the light emitting component at the high angle occurs based on presence or absence of the top surface in the pattern 130 in FIGS. 3 to 7.

In FIG. 21, an upper drawing illustrates a case when the top surface is not present between the first surface 131 and the second surface 133 of the pattern 130 in FIGS. 3 to 7, and a lower drawing illustrates a case when a top surface 139 is present between the first surface 131 and the second surface 133.

Referring to FIG. 21, among various light incident to the light guide member, there are a light component L0 incident at an angle that allows total reflection and a light component L1 incident at a low angle (nearly parallel to a horizontal axis).

First, referring to the lower drawing of FIG. 21, the light component L1 incident at the low angle does not satisfy a total reflection angle at the first surface 131 of each pattern and is refracted instead of being reflected. The refracted light component L1 is refracted again at the top surface 139 and emitted upward through the light emitting surface 140. The light emitted through the light emitting surface 140 as described above is emitted at a high angle based on an axis perpendicular to the light emitting surface 140.

In contrast, referring to the upper drawing of FIG. 21, the light component L1 incident at the low angle does not satisfy the total reflection angle at the first surface 131 of each pattern and is refracted at the first surface 131 instead of being total-reflected at the first surface 131. The light component L1 refracted at the first surface 131 is refracted again at the second surface 133 and is total-reflected at the light emitting surface 140 instead of being emitted to the outside.

Referring again to FIGS. 19 and 20, since the top surface disposed between the first surface 131 and the second surface 133 of the pattern 130 as in FIG. 20 generates light emitting component at the high angle, the vertical light distribution may have only one peak as shown in FIG. 19 when there is no top surface. That is, when the top surface is not present between the first surface 131 and the second surface 133 of the pattern 130, the vertical light emitting component at the high angle may be suppressed or eliminated.

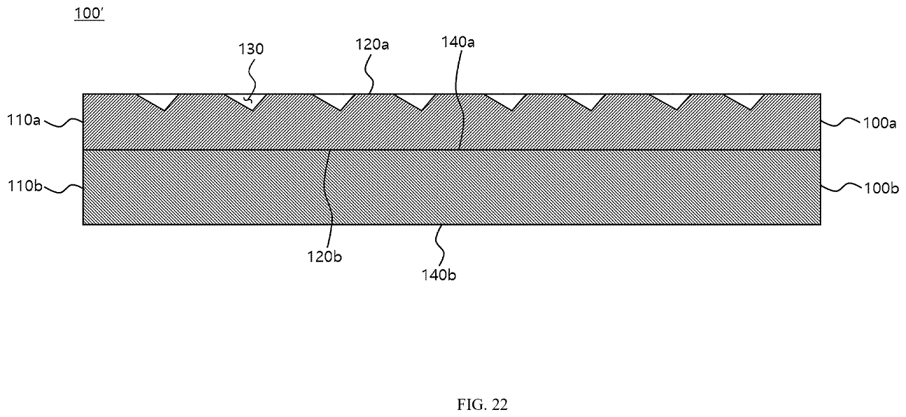

FIG. 22 is a cross-sectional view illustrating a light guide member 100′ according to another embodiment of the present disclosure.

Referring to FIG. 22, the light guide member 100′ according to another embodiment of the present disclosure further includes at least one light guiding layer for emitting light, which is disposed below the light emitting surface 140 of the light guide member 100 in FIG. 3.

More specifically, as illustrated in FIG. 22, the light guide member 100′ according to another embodiment of the present disclosure includes a first layer 100a and a second layer 100b.

The first layer 100a is disposed on the second layer 100b. Although not shown in the drawings, at least one additional layer may be also disposed between the first layer 100a and the second layer 100b.

The first layer 100a may include an incident surface 110a through which light is incident from the outside, a top surface 140a through which light is emitted, and a bottom surface 120a having a plurality of patterns 130. Here, since the plurality of patterns 130 are the same as those illustrated in FIGS. 3 to 7, a detailed description thereof will be replaced with the above description.

The second layer 100b may include an incident surface 110b through which light is incident from the outside, a top surface 140b through which light is emitted, and a bottom surface 120b disposed on the light emitting surface 140a of the first layer 100a.

The first layer 100a may have a thickness less than that of the second layer 100b.

The first layer 100a may be made of the same material as or a different material from that of the second layer 100b.

When the first layer 100a is made of a different material from that of the second layer 100b, luminance may decrease due to a difference between refractive indices or densities of the two layers. When the density of the patterns 130 is optimized, it is preferable to minimize the difference between the refractive indices of the two layers. Thus, when the first layer 100a and the second layer 100b are made of different materials, respective layers may be made of materials selected to minimize the refractive index of the first layer 100a and the refractive index of the second layer 100b.

For example, the first layer 100a may be made of a resin, and the second layer 100b may be made of a material of a general light guide plate such as polycarbonate (PC). Here, the first layer 100a may have a refractive index having a minimal difference from the refractive index of polycarbonate (PC), by which the second layer 100b is made.

The first layer 100a may be made of a soft material, and the second layer 100b may be made of a hard material. When the first layer 100a is made of a soft material, the first layer 100a may have an advantage of transferring the plurality of patterns 130.

The light guide member and the backlight unit including the same according to an embodiment of the present disclosure may be used to reduce the image defect without using the additional film. In particular, the light guide member and the backlight unit may reduce or eliminate the image defect such as the searchlight phenomenon and the rainbow pattern.

Also, the light guide member and the backlight unit may be mass-produced with low costs.

Although embodiments have been described with reference to a number of illustrative embodiments thereof, it should be understood that numerous other modifications and embodiments may be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A light guide member comprising:
an incident surface;
a pattern arrangement surface on which a plurality of patterns configured to reflect light incident through the incident surface are formed; and
a light emitting surface through which the light reflected from the plurality of patterns is emitted,
wherein each of the patterns is a concave pattern and defined by a plurality of surfaces formed on the pattern arrangement surface,
wherein the plurality of surfaces comprise a first surface that is convex in a direction toward the incident surface and a second surface that faces the first surface and is convex or concave in the direction toward the incident surface,
wherein an angle between the pattern arrangement surface and a cross-section obtained by cutting the first surface in a direction perpendicular to the incident surface is an obtuse angle, and
wherein an angle between the pattern arrangement surface and a cross-section obtained by cutting the second surface in a direction perpendicular to the incident surface is an obtuse angle.

2. The light guide member of claim 1, wherein the plurality of surfaces comprise:
a first side surface disposed at one side between the first surface and the second surface; and
a second side surface disposed at the other side between the first surface and the second surface, and
wherein each of the first side surface and the second side surface has a triangular or trapezoidal shape.

3. The light guide member of claim 1, wherein one side closest to the light emitting surface in the first surface and one side closest to the light emitting surface in the second surface are brought into contact with each other to form an edge, and
wherein the edge is a curve.

4. The light guide member of claim 1, wherein an angle between both ends of the first surface based on a center of a circle along which the first surface extends is an acute angle.

5. The light guide member of claim 1, wherein the first surface has a width equal to or greater than 15 μm and equal to or less than 30 μm.

6. The light guide member of claim 5, wherein the first surface has a curvature equal to or greater than 5 μm and equal to or less than 30 μm.

7. The light guide member of claim 1, wherein the first surface has a width equal to or greater than a height of the pattern.

8. The light guide member of claim 1, wherein the first surface has an inclination angle equal to or greater than 50° and equal to or less than 60°.

9. The light guide member of claim 1, further comprising at least one light guide layer disposed below the light emitting surface.

10. A backlight unit comprising:
a light guide member comprising:
an incident surface;
a pattern arrangement surface on which a plurality of patterns configured to reflect light incident through the incident surface are formed; and
a light emitting surface through which the light reflected from the plurality of patterns is emitted,
wherein each of the patterns is a concave pattern and defined by a plurality of surfaces formed on the pattern arrangement surface,
wherein the plurality of surfaces comprise a first surface that is convex in a direction toward the incident surface and a second surface that faces the first surface and is convex or concave in the direction toward the incident surface,
wherein an angle between the pattern arrangement surface and a cross-section obtained by cutting the first surface in a direction perpendicular to the incident surface is an obtuse angle, and
wherein an angle between the pattern arrangement surface and a cross-section obtained by cutting the second surface in a direction perpendicular to the incident surface is an obtuse angle;
a light source disposed at a side of the incident surface of the light guide member; and
a display panel disposed on the light emitting surface of the light guide member.

11. The backlight unit of claim 10, wherein the display panel comprises a plurality of pixels, and
wherein a distance between the plurality of patterns is equal to or less than one-third of a size of one pixel.

12. The backlight unit of claim 10, wherein the plurality of surfaces comprise:
a first side surface disposed at one side between the first surface and the second surface; and
a second side surface disposed at the other side between the first surface and the second surface, and
wherein each of the first side surface and the second side surface has a triangular or trapezoidal shape.

13. The backlight unit of claim 10, wherein one side closest to the light emitting surface in the first surface and one side closest to the light emitting surface in the second surface are brought into contact with each other to form an edge, and
wherein the edge is a curve.

14. The backlight unit of claim 10, wherein an angle between both ends of the first surface based on a center of a circle along which the first surface extends is an acute angle.

15. The backlight unit of claim 10, wherein the first surface has a width equal to or greater than 15 μm and equal to or less than 30 μm.

16. The backlight unit of claim 15, wherein the first surface has a curvature equal to or greater than 5 μm and equal to or less than 30 μm.

17. The backlight unit of claim 10, wherein the first surface has a width equal to or greater than a height of the pattern.

18. The backlight unit of claim 10, wherein the first surface has an inclination angle equal to or greater than 50° and equal to or less than 60°.

19. The backlight unit of claim 10, further comprising at least one light guide layer disposed below the light emitting surface.
